(19) United States
(12) Patent Application Publication
(10) Pub. No.: US 2005/0010326 A1
(43) Pub. Date: Jan. 13, 2005

(54) Method and apparatus for synthesizing virtual interaction between rigid and deformable bodies

(76) Inventors: Vincent Hayward, Montreal (CA); Mohsen Mahvash-Mohammadi, Montreal (CA)

Correspondence Address: David J. French;Suite 700, 225 Metcalfe Street, Ottawa, ON, K2P 1P9, CA

(21) Appl. No.: 10/854,799

(22) Filed: May 27, 2004

Related U.S. Application Data
(60) Provisional application No. 60/473,445, filed on May 28, 2003.

(51) Int. Cl. G06F 19/00

(52) U.S. Cl. 700/182; 700/189

(57) ABSTRACT

To synthesize the response for a virtual contact resulting from rigid object acting on a deformable body, a method is used whereby the surface of the virtual deformable body carries a finite set of responses corresponding to actual responses between the object and the body which are calculated or measured in a preprocessing step and stored into memory. The virtual deformable body is also meshed into polygons. When an object force interacts with the deformable body, an initial point of contact is made. The polygon that includes the point of contact is identified and is termed the active polygon. The relative position of the point of contact within the currently active polygon is determined. Response data associated with the currently active-polygon is obtained from the memory and the response is synthesized for any point on the surface of the rigid object. The synthesis includes the reproduction of friction. Frictionless contacts are synthesized as a special case when a presliding distance is set to zero. This applies equally to impedance synthesis, whereby a force is found from a displacement, or to admittance synthesis whereby a position is found from a force. By accessing pre-processed response data, the computational complexity is reduced, while the determination of the relative position of the point of contact within the currently active polygon makes it possible use a double interpolation process that, ensures continuity of rendered forces and the passivity of the synthesized interaction although the original data is known only at a discrete locations.

This application claims the benefit of prior provisional application Ser. No. 60/473,445 filed May 28, 2003.

### FIELD OF THE INVENTION

The present invention relates generally to computer based simulation of the behavior of solid objects when they come into contact and, in particular, to methods and apparatus for synthesizing accurately the virtual interaction between a rigid object and a deformable body, as it is needed to provide for sensory feedback in haptic simulations.

### BACKGROUND OF THE INVENTION

Computers can be used in many instances to predict the behavior of material objects. It is often needed to provide these predictions with a number of computation steps which is known in advance for any of the cases considered by the simulation. This knowledge makes it possible to design computer simulations which are performed in real-time. This is because, with computers, simulation of a material system must be performed from one time step to the next. If it is possible to know a fixed upper bound to the number of computation steps required to compute the state of the simulated system as it changes from one time step to the next, then it is possible to design a computer system able to performing a sufficient number of computation steps per unit of time to provide a sequence of simulation steps rapid enough to approximate closely the behavior of the material objects being simulated.

More specifically, a haptic display enables a user to experience sensory signals by means of a computer. Often it is needed to compute signals related to the behavior of objects coming into contact and to transform these signals into forces or movements to be experienced by a user. To provide the ability to experience these artificially created signals, computations can be performed on the basis of the user's motions which are tracked by a haptic device, or on the basic of forces applied by a user which are measured by the device. The process of computing and generating mechanical signals in response to user interactions is sometimes called haptic rendering. To reduce the possibility of confusion with techniques in computer graphics, a preferred term used in this disclosure is interaction synthesis. Applications and areas that implement interaction synthesis include training simulators, computer aided design and entertainment.

Herein, the term force will mean force and torques and the term position will mean position and orientation. Those of ordinary skill in the art will appreciate that interaction synthesis can be carried out in two possible ways. The most common method employs a haptic device which measures the position of a tool, or a handle, held by the user. When interaction between a virtual tool and a virtual body occurs, forces are computed in response to displacement and returned to the user by the haptic device. A less common method employs a haptic device which measure forces applied by a user to a handle. When interaction between a virtual tool and a virtual body occurs, the haptic device is commanded to move to a position corresponding to the measured force. The former method is often called impedance synthesis, while the latter is termed admittance synthesis. For each case, haptic devices are constructed or controlled in specific ways, but this has no consequence on the present invention.

Accurate synthesis of interaction must be performed in real-time in order to generate virtual interactions which, once reconstructed, will closely resemble actual mechanical interaction. Therefore, to reconstruct details, a computer will have only a brief amount of time in which to compute the virtual interaction after receiving the user's input. For example, if the interaction causes forces to change significantly during a time interval of a 10 millisecond, reconstruction must occur at intervals of about 1 millisecond.

During synthesis, to compute forces (or positions) resulting from a contact between rigid bodies, it acceptable to assume that the bodies contact at one, or few points in close proximity, in order to represent the shape, texture and the position of a body. When one body is rigid and one body is deformable, the virtual contact must simulate the local details of the interaction because the virtual contact depends on the shape of the rigid body, on the elastic properties of the deformable body, on how it is supported, and on its shape. For example, assuming that bodies contact at just one point, or even at a few points, precludes the possibility to design a simulation able to distinguish between a blunt tool and a sharp tool. An accurate representation of these factors has importance for surgical simulators among other applications.

Various methods of simulation for body deformation in computer graphics and haptics have been developed. However, current methods do not simulate contact interaction resulting from local deformation. Specifically, when the deformation of a body is localized around a point of contact, the force of contact as a result of position displacement depends on the shapes of the objects in contact. For example, the shape of a rigid tool used to cause deformation of a deformable object has a critical effect on the force resulting from displacement. A sharp tool will produce a small force given a small indentation, while a blunt tool will produce a large force for the same displacement. Alternatively, a given force applied to a locally deformable body by a rigid tool results in different positions and hence difference deformations, according to the shape of the tool. This is in contrast to an elastic body that is globally deformed, for which a crude representation of contact can suffice to predict the force of contact (or the displacement given a force), since the deformation energy is distributed everywhere in the body. In such cases, only the resultant force is important, but not the force distribution in the zone of contact. A special case is to represent the zone of contact by a single point for computational expediency.

Thus, it is apparent that a point contact representation used to simulate virtual interactions between bodies is an idealization which is not sufficient to distinguish between knifes, forceps, or blunt tools interacting with dead or living tissues, or with other materials possibly including soils, or fabrics. Hence, there is a need to provide an improved method of haptic simulation that will provide realistic simulations of contact interaction with a deformable body, whether there is local deformation or global deformation, and that is independent of material homogeneity, isotropy, and linear elasticity of the body, all of which critically influence the behavior of a contact.

### SUMMARY OF THE INVENTION

In accordance with one aspect, the present invention addresses a method for synthesizing a response to interaction between a simulated tool having a tip and a simulated, deformable body model having its surface modeled as being divided in a plurality of adjacent polygons, preferably triangles, said method comprising the steps of:
a) receiving data from a data-source device indicative of the position of said tip on the simulated tool relative to the position of a point of initial contact between the tool tip and the undeformed simulated body;
b) displacing the tool tip to establish a deflection from said point of initial contact;
c) determining the deflection from said point of initial contact from the difference between the position of the simulated tool tip and the point of initial contact;
d) identifying the active polygon that includes the point of initial point of contact;
e) determining the position of the point of initial contact within the active polygon;
f) interpolating coordinate systems having at least one coordinate recorded with respect to each of the vertices of the active polygon;
g) interpolating from the components of the deflection, the force response along each said coordinate from responses recorded at the vertices of the active polygon to provide data indicative of the force response at the point of contact, and
h) sending to a data receiving device the data indicative of the force response at the point of initial contact as a synthesized force signal constituting a synthesized to response.

By a further feature, the invention comprises a method for synthesizing a response to interaction between a simulated tool having a tip and a simulated deformable body model having its surface modeled as being divided in a plurality of adjacent polygons, said method including the steps of:
a) receiving data from a data-source device indicative of the position of said tip relative to the position of a point of initial contact between the tool tip and the undeformed simulated body and indicative of the force associated with the tool tip as it contacts the surface;
b) displacing the tool tip to establish a deflection from said point of initial contact;
c) identifying the active polygon that includes the point of initial point of contact;
d) determining the position of the point of initial contact within the active polygon;
e) interpolating coordinate systems having at least one coordinate recorded with respect to each of the vertices of the active polygon;
f) interpolating from the components of the force, the displacement response along each said coordinate from responses recorded at the vertices of the active polygon to provide data indicative of the displacement response at the point of contact, and
g) sending to a data receiving device the data indicative of the displacement response at the point of initial contact as a synthesized displacement signal.

According to another aspect of the invention, a method for synthesizing a response of a simulated tool sliding over a simulated deformable body model includes the step of permitting the point of initial contact to move over the surface of the undeformed body such that the magnitude of the tangential component of the deflection projected over the surface of the undeformed body is smaller than a bound that depends on the normal deflection component. This method can be employed wherein the deflection data arising from the point of initial contact, upon moving said point of contact over the surface, is preserved at the value created when the point of contact is about to leave the active polygon until data for a new active polygon is established, and thereafter is determined by the deflection data for such new active polygon.

The above methods may be adapted such that the magnitude of the tangential component of the force projected over the surface of the undeformed body is smaller than a bound that depends on the normal force component. Further, the force data arising from the point of initial contact, upon moving said point of contact over the surface, may be preserved at the value created when the point of contact is about to leave the active polygon until data for a new active polygon is established, and thereafter is determined by the force data for such new active polygon.

For all methods as described which are high rate processes, a process may be provided that is suitable to deliver, at low rate, response data having a lag and associated with an active polygon such that, if the response data represents a conservative force field, the synthesized force signal is dissipative with respect to displacement. This process comprises the detection of establishment of virtual contact and removing from the deflection the offset corresponding to the lag in said detection of establishment of the virtual contact.

The invention also addresses synthesizing a response to an input force acting on a deformable body having a surface modeled as a mesh of polygons, preferably triangles, said method comprising:
a) receiving data indicative of an input force acting on the deformable body at a point of contact;
b) identifying the polygon that includes the point of contact, said polygon being a currently active polygon;
c) determining a relative position of the point of contact within the currently active polygon;
d) obtaining force response data associated with the currently active polygon;
e) jointly processing the force response data and the relative position to produce data indicative of a force that is reactional to the input force; and
f) outputting the data indicative of the force that is reactional to the input force.

This method can be applied wherein receiving data indicative of an input force acting on the deformable body at a point of contact comprises receiving a deflection conveying an input force magnitude and an input force direction with respect to the point of contact. It can also be applied wherein determining a relative position of the point of contact within the currently active polygon comprises determining a weight associated with each of the vertices of the currently active polygon.

According to another aspect of the invention, obtaining force response data associated with the currently active polygon comprises loading the force response data associated with the currently active polygon from a memory. This may be combined with, prior to loading the force response data into the memory, computing the force response data on the basis of physical measurements, on the basis of analytical data, or on the basis of a simulation.

Thus, each polygon in a mesh of polygons may be defined by a plurality of vertices, wherein loading the force response data associated with the currently active polygon comprises loading force response data associated with each vertex of the currently active polygon. Such force response data associated with each vertex of the currently active polygon may convey a magnitude and a direction of the force response at that vertex, optionally in each of at least two basis directions.

Such basis directions may include a first basis direction and a second basis direction, wherein the magnitude component in the first basis direction is a first magnitude component and wherein the magnitude component in the second basis direction is a second magnitude component, and wherein the force response data associated with each vertex of the currently active polygon further conveys the first and second basis directions.

According to a further aspect of the invention, jointly processing the force response data and the relative position to produce data indicative of a force that is reactional to the input force comprises:
a) determining a first basis direction for the reactional force from the first basis direction of each vertex in the active polygon and the weight associated with that vertex;
b) determining a second basis direction for the reactional force from the second basis direction of each vertex in the active polygon and the weight associated with that vertex.

Such steps may alternately produce data indicative of a force that is reactional to the input force by inclusion of steps comprising:
a) determining a first magnitude component for the reactional force from the first magnitude component of each vertex in the active polygon and the weight associated with that vertex;
b) determining a second magnitude component for the reactional force from the second magnitude component of each vertex in the active polygon and the weight associated with that vertex.

This method may be pursued wherein the data indicative of the reactional force conveys a vector that is the sum of the first magnitude component for the reactional force in the first basis direction for the reactional force and the second magnitude component of the reactional force in the second basis direction for the reactional force.

The method may also be pursued wherein the data indicative of the reactional force conveys a vector having:
a) a first component with a magnitude corresponding to the first magnitude component for the reactional force and a direction corresponding to the first basis direction for the reactional force;
b) a second component with a magnitude corresponding to the second magnitude component for the reactional force and a direction corresponding to the second basis direction for the reactional force.

According to a further aspect, the methods of the invention may comprise:
a) receiving data indicative of a second input force acting on the deformable body at a second point of contact;
b) identifying the polygon that includes the second point of contact, said polygon being a new currently active polygon; and
c) determining a relative position of the second point of contact within the new currently active polygon;

Then, if the new currently active polygon is different from the currently active polygon,
d) obtaining force response data associated with the new currently active polygon;
e) jointly processing the force response data associated with the new currently active polygon and the relative position of the second point of contact within the new currently active polygon to produce data indicative of a force that is reactional to the second input force; and
f) outputting the data indicative of the force that is reactional to the second input force.

Alternately, a further aspect, the methods of the invention may comprise:
a) receiving data indicative of a second input force acting on the deformable body at a second point of contact;
b) determining whether it is time to update the currently active polygon; and, if it is time to update the currently active polygon:
c) identifying the polygon that includes the second point of contact, said polygon being a new currently active polygon;
d) determining a relative position of the second point of contact within the new currently active polygon;
   then, if the new currently active polygon is different from the currently active polygon,
e) obtaining force response data associated with the new currently active polygon;
f) jointly processing the force response data associated with the new currently active polygon and the relative position of the second point of contact within the new currently active polygon to produce data indicative of a force that is reactional to the second input force;
   but if it is not time to update the currently active polygon:
g) determining a relative position of the second point of contact within the currently active polygon;
h) jointly processing the force response data associated with the currently active polygon and the relative position of the second point of contact within the currently active polygon to produce data indicative of a force that is reactional to the second input force; and
i) outputting the data indicative of the force that is reactional to the second input force.

This method can be repeatedly performed and can be continued until an Nth execution of step h) yields that it is time to update the currently active polygon, N being greater than one.

The method of the invention can further comprise synthesizing the force that is reactional to the input force and this can be done by applying the force that is reactional to the input force to a physical tool. This can be obtained by applying the input force on the deformable body using the physical tool.

According to a further aspect of the invention, an apparatus for synthesizing a response to an input force acting on a deformable body having a surface modeled as a mesh of polygons, comprises:
a) an input for receiving data indicative of an input force acting on the deformable body at a point of contact;
b) a processing unit operable to:
   identify the polygon that includes the point of contact, said polygon being a currently active polygon;
   determine a relative position of the point of contact within the currently active polygon;
   obtain force response data associated with each vertex of the currently active polygon;
   jointly process the force response data and the relative position to produce data indicative of a force that is reactional to the input force; and
c) an output for releasing the data indicative of the force that is reactional to the input force. The precessing unit may also operate to execute any of the other processed referenced above.

This apparatus may further comprise a memory unit for storing the force response data associated with each of the polygons. The processing unit is then operable to obtaining force response data associated with the currently active polygon by loading the force response data associated with the currently active polygon from the memory.

The invention further includes computer-readable media tangibly embodying a program of instructions executable by a computer to perform a method of synthesizing a response to an input force acting on a deformable body having a surface modeled as a mesh of polygons, the method comprising:
a) receiving data indicative of an input force acting on the deformable body at a point of contact;
b) identifying the polygon that includes the point of contact, said polygon being a currently active polygon;
c) determining a relative position of the point of contact within the currently active polygon;
d) obtaining force response data associated with the currently active polygon;
e) jointly processing the force response data and the relative position to produce data indicative of a force that is reactional to the input force; and
f) outputting the data indicative of the force that is reactional to the input force.
   Such media may also embody a program to effect any of the other methods referenced above.

These and other aspects and features of the present invention will now become apparent to those of ordinary skill in the art upon review of the following description of the invention in conjunction with the accompanying drawings.

### BRIEF DESCRIPTION OF THE DRAWINGS

In the accompanying drawings:

FIG. 1 shows in block diagram form, a computer system having a memory and processing unit for synthesizing a virtual interaction in accordance with an embodiment of the present invention;

FIG. 2a shows a virtual deformable body in its undeformed state represented with its boundary modeled in accordance with an embodiment of the present invention;

FIG. 2b shows a virtual rigid object initially coming into contact with a virtual deformable body at point c common to the boundary of the rigid object and the deformable body.

FIG. 2c shows a virtual rigid object interfering with a virtual deformable body. Point c, the point of initial contact is on the boundary of the undeformed deformable body. Point x is the point on the boundary of the virtual rigid object which initially coincided with c. An actual material body would be deformed by a real tool so that no actual interference would occur.

FIG. 3 illustrates a polygon with three vertices showing a point of contact within the polygon and a force response at each vertex;

FIG. 4 illustrates the polygon of FIG. 3 divided into three areas sharing, as a common vertex, the point of contact, and

FIG. 5 is a flowchart showing steps in operation of the processing unit of FIG. 1 in order to synthesize a force for a haptic interaction with a single process.

FIG. 5a is a sub-flowchart of flowchart of FIG. 5 which needs to be followed to account for the synthesis of artificial friction.

FIG. 6 is a flowchart showing steps in operation of the processing unit of FIG. 1 in order to synthesize a force for a haptic interaction with a two processes, one running at high rate and the other running at low rate.

FIGS. 6a and 6b are sub-flowcharts of flowchart of FIG. 6 which need to be followed to account for the synthesis of artificial friction.

FIG. 7 shows in block diagram form, a computer process for synthesizing a virtual interaction in accordance with an embodiment of the present invention communicating with another computer process for synthesizing a virtual interaction which is graphically represented;

### DETAILED DESCRIPTION OF THE EMBODIMENTS

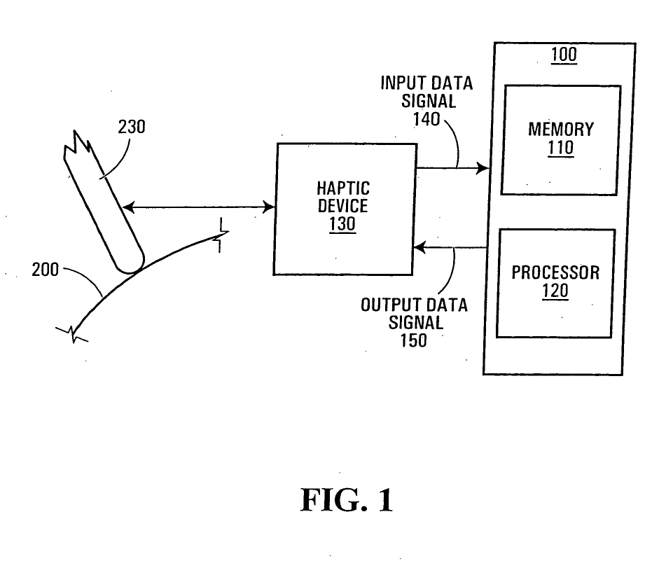

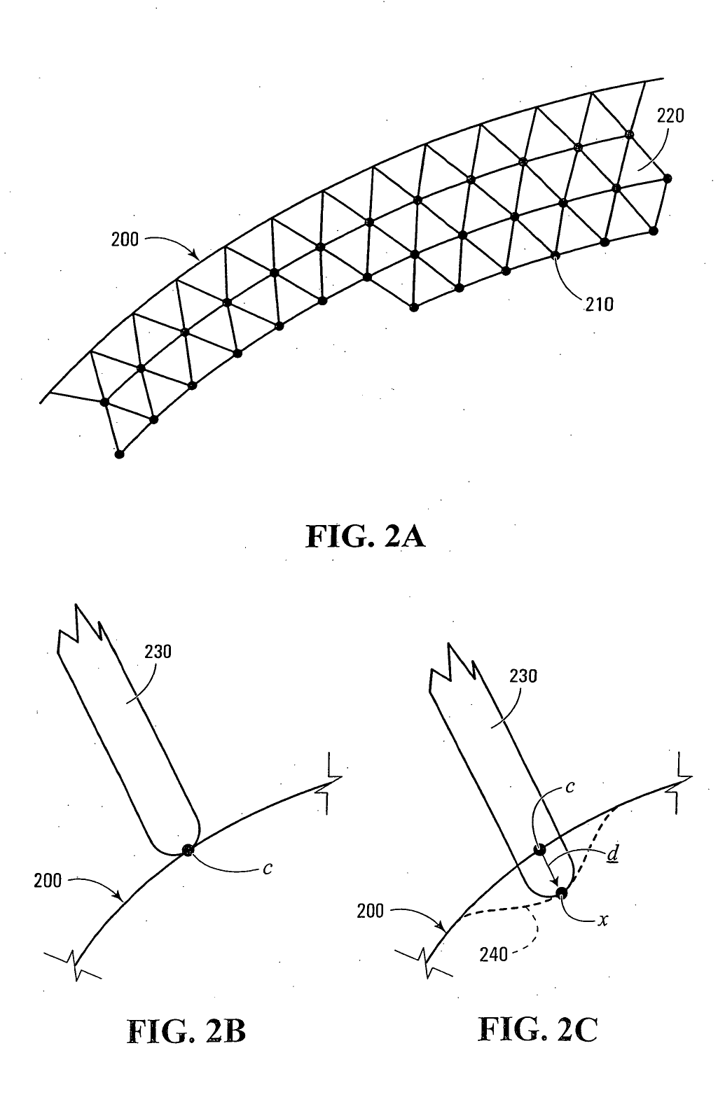

With reference to FIGS. 1, 2a, 2b, 2c, there is provided a haptic device 130, which is operative to simulate the interaction of a virtual rigid object 230 upon virtual contact with a virtual deformable body 200. The device 130, which may be endowed with realistic physical features such as a handle, will typically be manipulated by an external user during a training maneuver, e.g., for surgery, butchering, engraving, sushi slicing, etc. A coordinate frame of reference is used to register the position of the virtual rigid object 230 and of the virtual deformable body 200 when it is undeformed. Thus, the deformable body 200 is “virtual” and hence nonexistent in reality, although the trainee will perceive it to be present based on the synthesized virtual interaction between a tool and a body computed by the computer 100 and transformed into actual forces or displacements by the haptic device 130 as described herein below. It should be noted that the case of the rigid tool is provided by way of illustration only and that the method disclosed thereafter would apply equally well if the object virtually held by the user is deformable and moved by the user against a virtual rigid body.

As shown on FIG. 1, the haptic device 130 is configured to produce a signal 140 indicative of the position of the parts intended to be in actual contact with the user. In some cases, the haptic device 130 is configured to produce a signal indicative of the force exerted on this parts by the user. The haptic device 130 specifies the motions of the rigid object 230 within the coordinate frame of reference and, based on prior knowledge of its shape and of the location and shape of the deformable body 200, determines when the held object 230 is about to contact the deformable body 200.

Referring to FIG. 2b, when the user has indeed moved the virtually held object 230 to an initial contact, a point denoted c is defined on the surface of the virtual deformable body 200. The point c is also defined on the virtually held object. It is apparent that while point c indicates the place of initial contact on an undeformed virtual body, the position of point c can be recorded and remain to be known after the virtual deformation of the body, irrespective of the shape and size of the bodies in contact.

Referring now to FIG. 2c, When the rigid held object 230 moves within the coordinate frame of reference the boundaries of the two undeformed objects interfere, and a virtual interaction occurs. The position x represents the position of point c on the surface of the rigid object after the contact has occurred. Equivalently, x represent the movement of the held object with respect to its initial position at the instant of contact. The virtual interaction can be determined from c and from x, because at each point of initial contact c, there exists a relationship that links the contact force to x. This relationship is termed the response at c. This will apply whenever two bodies contact initially at a point and when the subsequent deformation grows into a surface of contact. If in the course of the subsequent deformation, a second point of contact is established, the same method later described applies at this second point, and so-on.

As illustrated by FIG. 2a, specific embodiments of the present invention employ a method whereby the surface of the virtual deformable body 200 is represented by a mesh of polygonal patches defined by nodes (or vertices) 210 distributed throughout the surface of the body 200. In the specific embodiment shown in FIG. 2a, the patches are triangles. However, it is should be understood that any geometrical representation of the body 200 can be used, as the shape of the surface of the virtual deformable body 200 is only an approximation for an actual or imagined object. For example, the geometrical representation may consist of a variety of polygonal shapes, in addition to, or other than, triangles, each of these shapes defining a planar patch. If the application demands it, other geometrical representation schemes can be used. For example, a frequent industry choice is the Nonuniform Rational B-Splines know as NURBS which permits non planar curved shapes in two or three dimensions to be interpolated from knot points as it is well know by those skilled in the art. The choice of one scheme over another is guided by such considerations as accuracy—few NURBS patches will provide a similar accuracy as many flat patches—, availability of data, software standards and the like, but in has no bearing on the principle of the present invention.

The points x(t) and c(t) define a deflection d_{c}(t)=c(t)−x(t) (the time dependence quantities like those will be omitted from now on). Each such deflection d_{c} is vectorial in nature and thus is associated with a magnitude and a direction (where bold underline notation signifies a vector quantity) Once the system is operating and providing a reaction. For each point c of initial contact with the body, a force f_{c} is associated to a deflection d_{c}. In some embodiments, the signal x is provided as input data 140 to a computer system 100 equipped with a processing unit 120 and a memory 110. In some other embodiments, the signal f_{c} is provided as input data 140 of a computer system 100.

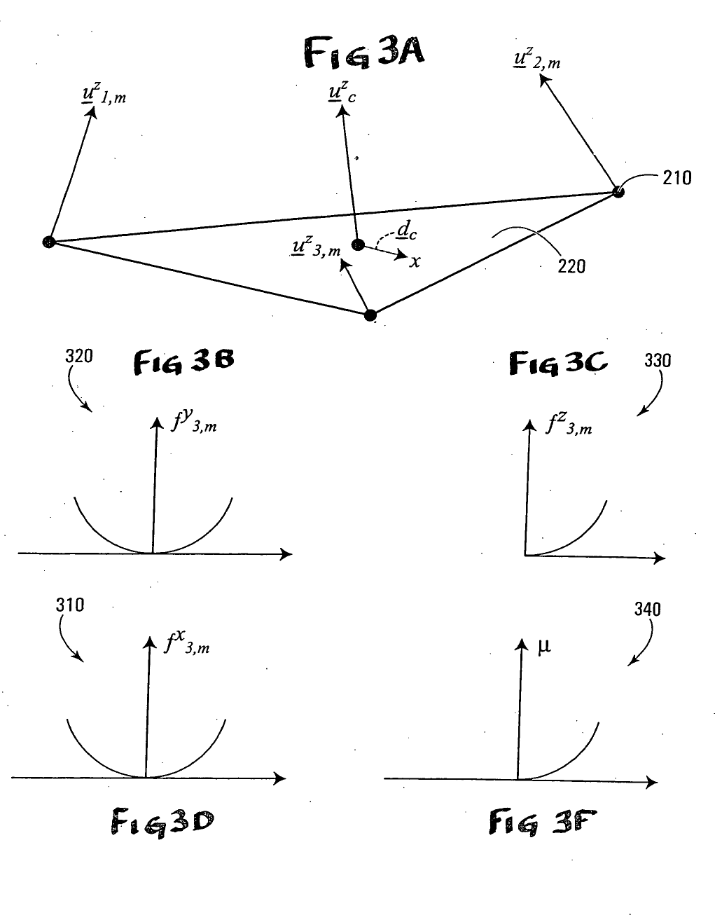

For each vertex 210 of the mesh made of patches 220 that represents the virtual deformable body 200, the memory 110 stores a set of basis vectors and associated response information as shown by FIG. 3. Specifically, the l^{th} vertex (l=1,2,3) of the m^{th} polygon is associated with a basis U_{l,m} comprising vectors u^{x}_{l,m}, u^{y}_{l,m}, and u^{z}_{l,m}. For the case of impedance synthesis, each vertex is associated with deflection force response curves in each of the basis directions, namely f^{x}_{l,m}( ), f^{y}_{l,m}( ), and f^{z}_{l,m}( ). For the case of admittance synthesis, each vertex is associated with force-deflection curves in each of the basis directions, namely d^{x}_{l,m}( ), d^{y}_{l,m}( ), and d^{z}_{l,m}( ). The choice for a particular basis U_{l,m} at each vertex is made purely on the basis of convenience as illustrated next.

It is noted that the deflection-force response curves or the force-deflection curves may be obtained during the course of a preprocessing stage using various approaches, such as finite element code, analytical solutions from first principles, by performing measurements made on physical samples, or by manually tuning parameters in order to reach a desired virtual interaction as experienced by the user. To make clear how such responses may be obtained, consider the example of an elastic block of homogeneous rubber bonded to a hard surface so that the deformation of the bonded surface is zero. Next consider a spherical tool indenting this block in a manner similar to tests which are performed to measure the hardness of materials, that is, in a direction perpendicular to the exposed surface. If the block if homogenous, to each deflection there will correspond a force in a direction orthogonal to the surface. In such special case, the vector u^{z}_{l,m} will be preferably chosen to coincide with the geometric normal vector to the surface of the undeformed body because, in this case, only one curve will have to be recorded. Consider next that the body is not homogeneous, that there is, for example, a steel ball embedded in the rubber in the vicinity of the point of initial contact. The same test performed by driving the spherical tool orthogonally into the surface will yield a response force which will be at an angle. Although the deflection is forced to have only one component, the force response may have three components. In this example, it is more economical to perform the test with the deflection aligned with response force and to select the vector u^{z}_{l,m} to be aligned in the same direction, since only one response curve will have to be recorded. However, during synthesis as will shortly be described, the result will be identical as-that obtained using an orthogonal deflection and three response curves.

The deflection-force or force-deflection response curves can be stored in the memory 110 as look-up tables, regression models, or function fit, for example. Generally speaking, the memory requirements for storing the deflection-force response curves (and the basis vectors) for individual nodes (vertices) are low. To illustrate, 240 megabytes of memory will suffice to represent the nonlinear response of an entire human body of 2 m² of surface at 1 mm of resolution using 6 million nonlinear deflection-force response curves, if it is assumed that 10 parameters, each occupying four bytes (a floating point number), are sufficient to specify-these curves and that each parameter is represented by a single precision floating point number. The 240 megabyte requirement for memory is easily satisfied by most conventionally available computers.

As will be described in greater detail later on, the processing unit 120 runs a program which processes the basis vectors and the deflection-force response curves or the force-deflection response curves in the memory 110 in accordance with the virtual deflection d_{c} (or the interaction force f_{c}) at the contact point c conveyed by the signal 140 to synthesize a virtual interaction. For impedance synthesis, the response force f_{c} is provided in the form of a signal 150 to an input of the haptic device 130. Upon receipt of the signal 150 from the computer system 100, the haptic device 130 applies the response force conveyed by the signal 150 to the tool 230. For admittance synthesis, the deflection d; is used to provide a position x=c−d_{c} in the form of a signal 150 to an input of the haptic device used to displace the held handle. In other instances, the interaction conveyed by the signal 150 can be displayed visually on a display or be processed by any other interface capable of transforming the output data signal 150 into forces or positions that can be sensed by the user, for example locally or at a remote location, or by other users, as in a classroom teaching situation.

For the case of impedance synthesis, upon sensing the response force, the user of the tool 230 will be under the impression that the tool 230 has come into contact with the virtual deformable body 200. For admittance synthesis, the user of the tool 230 will experience the tool being moved to the location it should occupy given force she or he applied to the deformable body 200 and will be under the impression that the tool 230 has come into contact with the virtual deformable body 200. Depending on the accuracy and speed with which the interaction is computed by the computer system 100 (and the accuracy and speed with which it is transformed by the haptics device 130 into actual forces or displacements), the force or the displacement felt by the user of the tool 230 approximates that which would have been felt, had the virtual deformable body 200 actually been present.

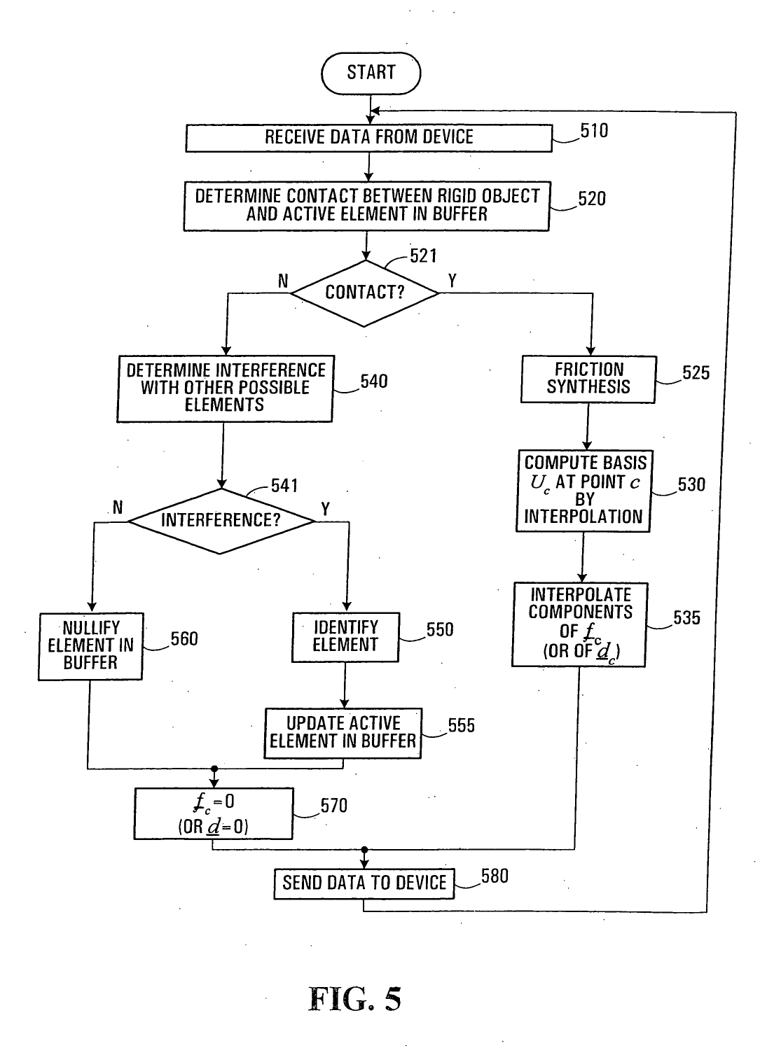

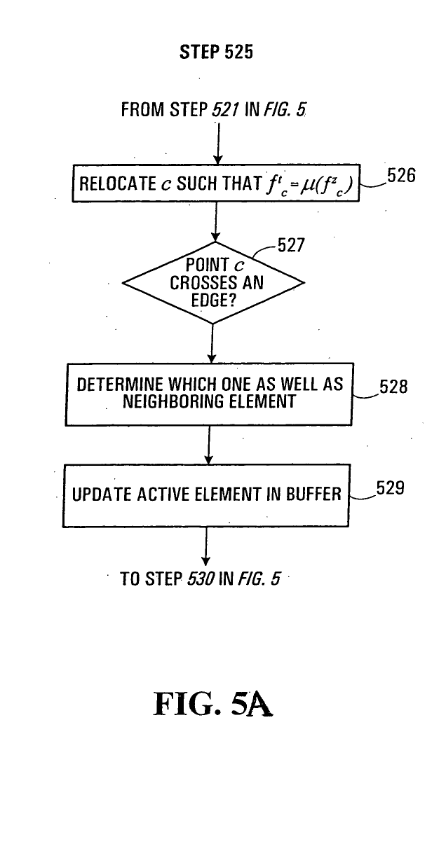

One possible algorithm 500 that can be executed by the processing unit 120 with a view to computing the signals needed to simulate a virtual interaction is now described with reference to the flowchart in FIG. 5.

At step 510, data indicative of an input position of the haptic device causing the virtual tool to come into contact at an initial point of contact c with the virtual deformable body 200 is received via the signal 140. After suitable coordinate transformations which are well known from those skilled in the art, the process is in a position to notify to another part of the processor the position of the held handle. The processor reserves a small amount of memory called a buffer the store all information relative to a patch m. The information relative to patch m is termed is active element. If no patch is active, the buffer contain a special element termed the null element. At step 520 the existence of point c is determined. It is a simple operation since it performed with reference to patch m only. There can be two outcomes to the test 521.

When there is no contact, the algorithm 500 proceeds with step 540 where possible interference with any other possible element is determined. As it is well known by those skilled in the art, this determination may in general consume an unpredictable number of steps since it typically involves search. Many methods are available to reduce the number of these steps typically relying on recursive data structures such as “octrees” or “oriented bounding box” (OBB) trees, else or in addition to methods which take advantage of coherence from one time step to the next, that is, to seed the search from the last element that was found to be in contact, including methods known in computer graphics as “picking” methods. However these improvements have no consequence on the present invention. In any case, given unpredictability, it is preferable to carry out interference detection in a separate process which will be detailed later on. For now, we consider that step 540 is performed in a small and predictable number of steps.

If an interference between the rigid and the deformable objects is detected, the algorithm branches at step 541 and the element which contains point c is identified at step 550 and corresponding the response data retrieved from memory and put in the buffer reserved for the active element at step 555. If no interference is detected, the active element is set to null at step 560. The device data is set to zero at step 570 before proceeding to the next iteration.

If the result of step 521 is in the case of contact between the rigid object and the active element, then at step 530, the processing unit 120 finds the data pertaining to the active polygon in the reserved buffer (the intervening step 525 will be described later and may be skipped for now). This data includes basis vectors u^{x}_{l,m}, u^{y}_{l,m}, and u^{z}_{l,m} for and deflection-force response curves for each of the vertices I=1,2,3 of the active polygon as illustrated by FIG. 3, where, by way of illustration, only basis vectors u^{z}_{1,m}, u^{z}_{2,m}, and u^{z}_{3,m} are indicated, and three symbolically represented responses 310, 320, 330 are shown at node 3 only. It is recalled that the deflection-force response curves may be calculated or measured in a preprocessing step, as described herein above.

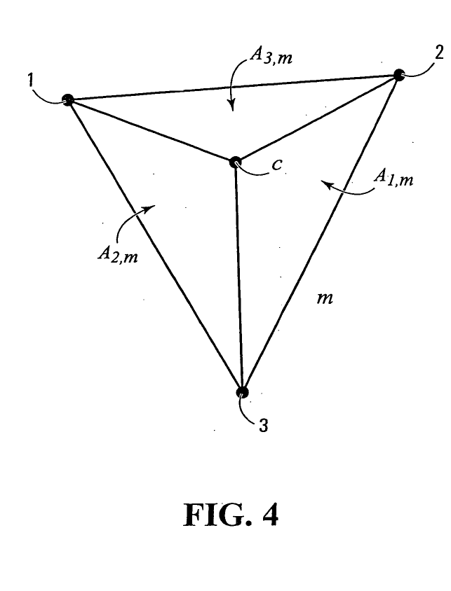

At step 530, the processing unit 120 proceeds to determine the relative position of the initial point of contact c within the active polygon m. This position can be used to define an interpolation having weights n_{l,m}(c), l=1,2,3. One suitable choice for the interpolation function n_{l,m}(c) is based on natural coordinates as it will be known from those skilled in the art:
n_{l,m}(c)=A_{l,m}(c)/Aₘ
where Aₘ is the area of the currently active polygon m and, as illustrated in FIG. 4, A_{l,m}(c) is the area of a triangle formed by c and the two vertices of m other than l. Of course, other choices for the interpolation function could be made and will be known to those of skill in the art. These weights are used to compute a basis U_{c} located at point c which was previously unknown. Specifically, with c being inside m (or even outside), the basis vectors u^{x}_{c}, u^{y}_{c}, and u^{z}_{c} are found by interpolation of the previously stored basis vectors u^{x}_{l,m}, u^{y}_{l,m,} and u^{z}_{l,m} at each vertex l belonging to the currently active polygon m. Using the previously defined interpolation weights n_{l,m}(c) for the l^{th} vertex of the currently active polygon m, the basis vectors at c can be calculated to form the basis U_{c}:
u^{x}_{c}=Σ_{l=1,3}n_{l,m}(c)u^{x}_{l,m}
u^{y}_{c}=Σ_{l=1,3}n_{l,m}(c)u^{y}_{l,m}
u^{z}_{c}=Σ_{l=1,3}n_{l,m}(c)u^{z}_{l,m}

At step 535, for impedance synthesis, the virtual contact force is, in principle, computed according to
f_{c}=f^{x}_{c}(d^{x}_{c},d^{y}_{c},d^{z}_{c})u^{x}_{c}+f^{y}_{c}(d^{x}_{c},d^{y}_{c},d^{z}_{c})u^{y}_{c}+f^{z}_{c}(d^{x}_{c},d^{y}_{c},d^{z}_{c})u^{z}_{c},
where d^{x}_{c}, d^{y}_{c}, and d^{z}_{c} are the components of d_{c} in the basis U_{c} as illustrated by FIG. 3.

However, in actual practice it often sufficient given a proper selection of the bases U_{l,m} to only consider the deflection components that have the greatest influence on corresponding force response component and to neglect the others:
f_{c}=f^{x}_{c}(d^{x}_{c})u^{x}_{c}+f^{y}_{c}(d^{y}_{c})u^{y}_{c}+f^{z}_{c}(d^{z}_{c})u^{z}_{c},
where d^{x}_{c}, d^{y}_{c}, d^{z}_{c} are the components of the deflection d with respect to the basis vectors at c. At step 535, the components of the virtual contact force, namely f^{x}_{c}(.), f^{y}_{c}(.), and f^{z}_{c}(.) are obtained from the stored displacement-force response curves and the interpolation weights in the following manner
f^{x}_{c}(d^{x}_{c})=Σ_{l=1,3}n_{l,m}(c)f^{x}_{l,m}(d^{x}_{c})
f^{y}_{c}(d^{y}_{c})=Σ_{l=1,3}n_{l,m}(c)f^{y}_{l,m}(d^{y}_{c})
f^{z}_{c}(d^{z}_{c})=Σ_{l=1,3}n_{l,m}(c)f^{z}_{l,m}(d^{z}_{c})

The resulting data representing the response force is output at step 580. It should be noted that in many cases, one could be satisfied with even more simplified representations of a contact. For example, the above set of equation may be replace by two: one for the response in the normal direction z and one in a radial direction r that provides the best fit (yielding cylindrical coordinates), or even just one in the normal direction.

For admittance synthesis, at step 535 the virtual contact position is computed applying the same simplifications according to
d_{c}d^{x}_{c}(f^{x}_{c})u^{x}_{c}+d^{y}_{c}(f^{y}_{c})u^{y}_{c}+d^{z}_{c}(f^{z}_{c})u^{z}_{c},
where f^{z}_{c} and f^{r}_{c} are the components of the force f_{c} exerted by the user on the handle along the basis vectors at c. The individual components of the virtual deflection, namely d^{x}_{c}( ), d^{y}_{c}( ), and d^{z}_{c}( ) are obtained from the stored displacement-force response curves and the interpolation weights in the following manner:
d^{x}_{c}(f^{x}_{c})=Σ_{l=1,3}n_{l,m}(c)d^{x}_{l,m}(f^{x}_{c})
d^{y}_{c}(f^{y}_{c})=Σ_{l=1,3}n_{l,m}(c)d^{y}_{l,m}(f^{y}_{c})
d^{z}_{c}(f^{z}_{c})=Σ_{l=1,3}n_{l,m}(c)d^{z}_{l,m}(f^{z}_{c})

Thus, the point of initial contact c displaced by d_{c} indicates the position of the virtual deflected-contact which-respect to c and hence the position x where the haptic device must be commanded to move to in order to simulate the interaction.

So far the we have described virtual interaction synthesis which did not involved sliding. In other words the simulated contact is sticking only. But before we describe the more general case of sliding virtual interaction, an improved algorithm is preferably needed to realize virtual interaction synthesis requiring a predictable number of computation steps to be accomplished within a set time period.

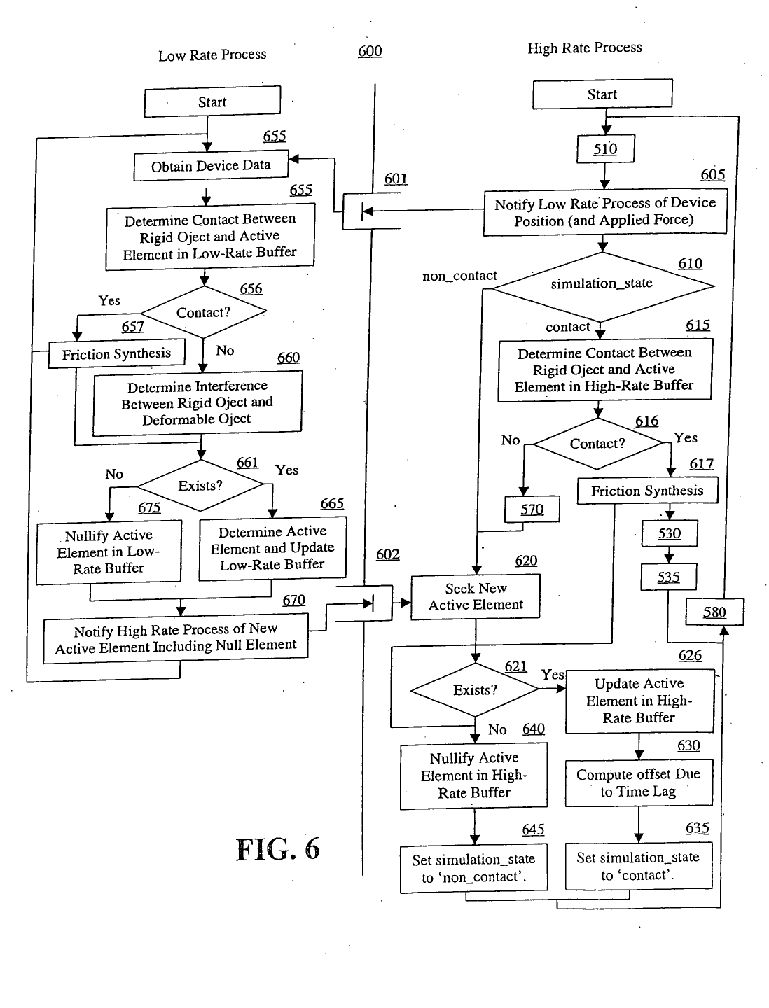

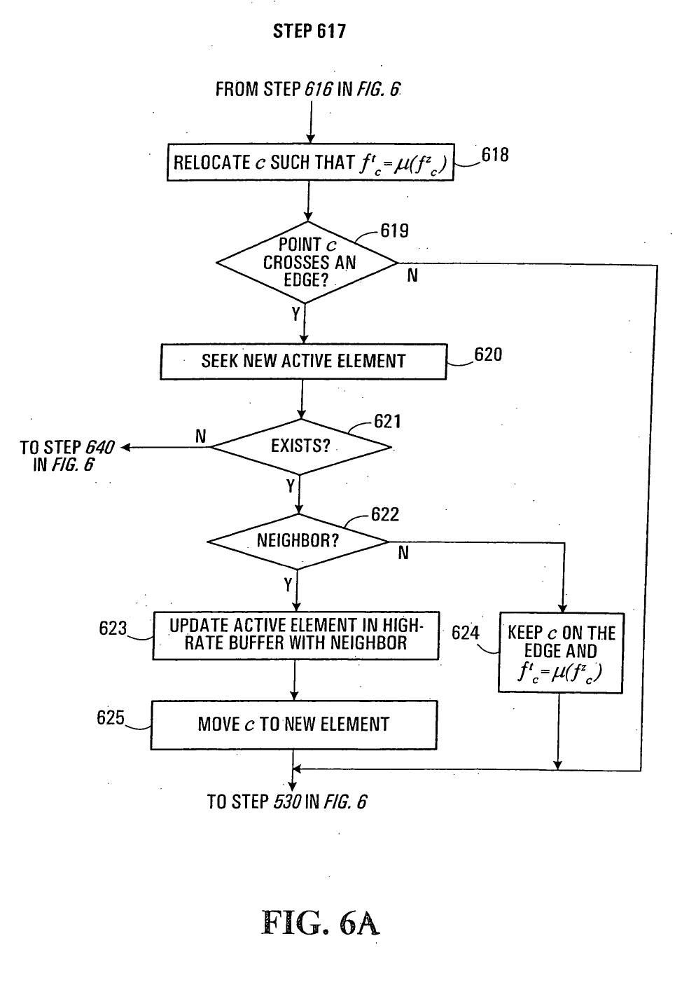

With reference to FIG. 6, there is provided a virtual contact synthesis method which operates from two or more processes and which has the advantage that the haptic device 130 receives simulation data at predictable rates, no matter how complicated is the process of determining interference and of retrieving (or computing) responses. Other advantages will be explained once the improved algorithm will be described.

The flowchart in FIG. 6 has two parts labeled High Rate and Low Rate referring to two computational processes or threads running at possibly two different update rates, one high, one lower. Since the two processes could possibly run asynchronously, possibly at rates which are not multiple of each other, devices 601 and 602 are provided to make communication possible. Such devices, which comprise a combination of software and hardware components, may be implemented in a computer have one-or several CPU via shared memory, semaphores, first-in-first-out queues, pipes, or over data links using remote procedure calls, sockets, user datagram protocol (UDP), transport or other protocols such as TCP/EP, Bluetooth, or hand-shaking procedures which are well known to those skilled in the art. It is thus apparent that the method disclosed herein is applicable to simulations which are performed with any network of computers, including computers interconnected via the links provided by the world-wide-web.

Instead of one single buffer to store the data pertaining to the active element, two are now provided, one for the high rate process and one for the low rate process, such that the data stored in the high rate buffer can be accessed frequently and predictably.

In the flowchart of FIG. 6, the high rate process is described first. Step 510 as before consists of obtaining device data. It is followed by step 605 that notifies the low rate process of this device data by means of the communication device 601. The high rate process maintain a state variable ‘simulation-state’ which can have one of two possible values ‘-contact’ and ‘-non-contact’. At step 610 the value of variable ‘simulation-state’ determines whether or not the high process needs to simulate a virtual contact. It the event it does, at step 615 the high process proceeds with the finding point c in the currently active element. As before, contact can persist or disappear, therefore step 616 can have two outcomes, corresponding to the same computational steps 530, 535, or 570. Once step 535 is performed, the data to be send to the device are known and are sent at step 580. Similarly, in the case of contact additional computations must me made to synthesize friction at step 617, but these will be detailed later and can be ignored now. In the non contact case, at step 620, the high rate process inspects the data communication device 602 to determine at step 621 whether the active element needs to be updated at step 626 or nullified at step 640. If the outcome of test 621 indicates that indeed no new element is supplied by the low rate process, the high rate buffer is nullified at step 640 and the simulation state set to ‘non_contact’. If a new element is found at step 621, because the update performed at step 626 pertains to a decision that was made in the past by the low rate process, it is likely that the user will have moved the virtual rigid object in the meantime by a significant amount. Corrective action is explained in the next paragraph. The simulation state is set to ‘contact’. In any case, for now a zero force (or deflection) will be sent to the device since step 570 was taken when the control reaches step 580.

One method hereby disclosed which provides a passive virtual interaction despite the combined actions of the low and high rate processes. This property will be further discussed later, but at step 630, it can be shown that it is sufficient that an additional variable be computed to compensate for the time tag. It suffices to compute a deflection offset d₀ which is such that the initial potential energy stored in the virtual interaction when a new element is activated is equal or smaller than the potential energy stored in the virtual interaction with the previous element at the moment it was replaced. Since any force, including virtual interaction forces, derive from a potential, we can call Eᵢ₋₁(x) the potential energy of virtual interaction at the time when the active element is replaced and Eᵢ(x) the initial potential energy of the virtual interaction of the new active element for the same position x of the virtual rigid body. It is well known that a necessary condition for passivity is:
Eᵢ(x)≦Eᵢ₋₁(x)

Among the several methods to enforce this inequality even though the new active element was determined at an earlier time than when it was activated, one of them can readily-be illustrated. Step 630 computes a deflection offset d_{c0i} which is substracted from d_{c} to ensure that Eᵢ(x)≦Eᵢ₋₁(x) is verified. By accounting for this offset, the force is computed from d_{c}−d_{c0i} according to
f_{c}=f^{x}_{c}(d^{x}_{c}−d^{x}_{c0i})u^{x}_{c}+f^{y}_{c}(d^{y}_{c}−d^{y}_{c0i})u^{y}_{c}+f^{z}_{c}(d^{z}_{c}−d^{z}_{c0i})u^{z}_{c}.
In addition, f_{c} should take the value zero when d^{z}_{c}<d^{z}_{c0i}.

The energy inequality is easily solved for d_{c0i} so that Eᵢ(x)=Eᵢ₋₁(x)=0. This deflection adjustment is applied immediately at the next iteration.

It is noted that because of the preprocessing performed in order to compute the deflection-force (or the force-deflection) response curves, there is no difficulty in computing the basis vectors at step 530 and the force (or the position) at step 535 in real-time. It is noted that the chosen interpolation function ensures continuity of the response force over the surface of the virtual deformable body 200, but-that any other interpolation function providing continuity could be used. It is also noted that realism in the simulation of the interaction results from two interpolation steps: one to determine the basis vectors at the point of initial contact c, and one to determine the response of the interaction, be it via the impedance or via the admittance method. This is because the synthesized signals result from the products and sums of individually continuous quantities.

Refering again to FIG. 6 this time to describe the low rate process which begins each iteration with step 655 where the device position is obtained from the communication device 601, perhaps with some time lag. It then proceeds with determining at step 655 whether there is contact with the element stored in low rate buffer. If indeed there is contact, then it proceeds with step 657 dedicated to take the steps necessary to synthesize friction and which will be described in greater detail later. If there is no contact, then the possibility exists that the rigid object could be interfering with the deformable object or objects at any location. The step 660 to determine this could be time consuming. If interference exists, something which is check at step 661, then a new active element is found at step 665 and placed in the low rate-buffer. If there is no interference, then this is indicated by placing a null element in the low rate buffer. The result of these computation is then notified to the high rate process via communication device 602 before returning to step 655.

It is apparent from the foregoing that the approach used to model the haptic interaction is applicable to almost arbitrary shapes of bodies in contact and can be employed whether the bodies are homogeneous or not, isotropic or not, linear-elastic or not. Moreover, the method is not limited to the case where the simulated deformable body has a fixed shape and fixed material properties. If it is desired to simulate virtual interaction with bodies that vary with time, for example to simulate the interaction with a beating heart or a heaving diaphragm in a surgical simulation application, the determination of the point c of initial and sliding contact will be carried out with a time-varying body boundary rather than a fixed one as it was described so-far. To make this point obvious, consider that the position of the virtual object driven by the hand of the user was considered to vary with time. So-far, the determination of the deflection at each step in time was carried out using the formula d_{c}=c−x. Exactly the same method will apply if the boundary of the virtual body varies under the action of agents such as muscle contraction or change in blood pressure as in the simulation of living tissues which are independent from the movements of the user. In such cases, x would represents the relative position to a point of initial contact on a varying-boundary. The boundary of the simulated body can change, for example cyclically, but the interpolation equations remain the same.

Similarly, it could be desired that the virtual interaction simulation be made dependent on changes in the materials properties. An example of such need is found in the simulation of surgical procedures where changes in material properties could be result of variations due to physiological factors such as haemostatic or haemodynamic phenomena, slow diffusion of fluids, muscle contraction and others, then exactly the same simulation method described in the foregoing would apply but now making the force deflection or the deflection force curves depend on additional continuous states based on the time derivatives of d_{c} (d′_{c}, d″_{c}) or of discrete states-(s₁, s₂, . . . , sₙ). The only modification then would be to provide for different responses corresponding to these states. These different responses are noted with left superscripts

This will then yield for impedance synthesis
f_{c}=f^{x}_{c}(d^{x}_{c},d′^{x}_{c},d″^{x}_{c})u^{x}_{c}+f^{y}_{c}(d^{y}_{c},d′y_{c},d″^{y}_{c})u^{y}_{c}+f^{z}_{c}(d^{z}_{c},d′^{z}_{c},d″^{z}_{c})u^{z}_{c}
but now, using additional interpolation coefficients wᵢ(v₁,v₂, . . . ,vₚ) where the variables vᵢ represent additional physical factors that have influence on the resulting force, and where the force components ^{S}ᵢf^{x}_{c}, ^{S}ᵢf^{y}_{c}, and ^{S}ᵢfy^{x}_{c} along each coordinates are in turn interpolated according to the position of point c (or projections of c):
f^{x}_{c}(d^{x}_{c},d′^{x}_{c},d″^{x}_{c},v₁,v₂, . . . ,vₚ)=wᵢ(v₁,v₂, . . . ,vₚ)^{S}if^{x}_{c}(d^{x}_{c},d′^{x}_{c},d″^{x}_{c})
f^{y}_{c}(d^{y}_{c},d′^{y}_{c},d″^{y}_{c},v₁,v₂, . . . ,vₚ)=wᵢ(v₁,v₂, . . . ,vₚ)^{S}if^{y}_{c}(d^{y}_{c},d′^{y}_{c},d″^{y}_{c})
f^{z}_{c}(d^{z}_{c},d′^{z}_{c},d″^{z}_{c},v₁,v₂, . . . ,vₚ)=wᵢ(v₁,v₂, . . . ,vₚ)^{S}if^{z}_{c}(d^{z}_{c},d′^{z}_{c},d″^{z}_{c})
For admittance synthesis, a similar method applies but to deflection-force responses.

In such more general cases, the same assurances of continuity of the simulated interaction, of accuracy, and of low computational demand will be provided, given the two step interpolation process, if the variations of the boundary and of material properties as smooth functions of time. Similarly, the same method applies for even more general cases needed, for example, to represent plasticity, visco-elastic relaxation, fluid shift, or damage of materials where now the response curves can be multi-valued and branch at reversal points. In these even more general cases, the same assurances of continuity of the simulated interaction, of accuracy, and of low computational demand will be provided, given the two step interpolation process described, provided that the response curves are continuous. An example of simulation of varying material properties due to the cutting action of a sharp tool causing the responses to vary according to the depth of cutting crack with two discrete interaction-states was provided in (Mahvash and Hayward 2001). The same method applies equally well to this more general case.

Another important case in which the same method applies is when interaction depends on the location of x with respect to the rigid object. In such case, three variables v₁, v₂, and v₃ may be used to represent the position of x with respect to the rigid object (such as when rolling is synthesized). If even more realism is required to account for this dependency, several states s₁, s₂, . . . , sₙ, may be used to account for location of x with respect to a mesh used to approximate the rigid object geometry. Force-deflection (or deflection-force) responses are predetermined im each of these states and the above interpotation equations are employed. Similarly, the interpolation weights may be computed from area coordinates to define appropriate weigthing functions wᵢ.

When artificially created friction is of importance, its effect can be conveniently be included in the simulation of virtual interactions between bodies. From the work of Dahl (1969) it is 1 wt that the effect of friction may be viewed as the result of tangential elastic deformation of surfaces in contact. When the tangential load remains under a threshold, by definition of elasticity, loading and then unloading tangentially a contact will cause it to return to its initial state. When the loading exceeds the said threshold, a permanent change is made, the surfaces slip with respect to one another, something which is analogous to plasticity (Hayward and Armstrong 2000, Dupont et al. 2002. In these references a defect of the original description by Dahl which can-be shown to lack the sticking phase is corrected). While this was intended to describe the behavior of friction between hard solids, that is, at microscopic scales, it applies equally well to deformable bodies but with the difference that the relative displacement between the bodies is allowed to occur at macroscopic scales. Thus, this difference is only quantitative but not qualitative. Consider for example the case of an object in contact with the skin at the back of the hand. Movements of this object over distances of many millimeters cause elastic deformation of the skin before slip occurs, but past a certain distance, slip takes pace. Upon reversal, slip is removed. At microscopic scales, these movements are known to those skilled in art as pre-sliding movements and hence, this term applies equally to the tangential deformations of deformable bodies. During presliding force and displacement are related by an elastic behavior. During sliding, the tangential force component is rather independent from the contact area but greatly dependent on the normal force component, as stated by Amontons' laws

It is therefore apparent that the synthesis of virtual interactions between deformable bodies described thus far is only a special case of the more general case of interaction with friction. It is the special case when the bodies in contact are in the stuck state, and therefore, the quantities needed to simulate friction with finite presliding have already been introduced.

Recalling that given the boundary of an undeformed body, an initial point of contact c is defined on it. When the body deforms after contact due to the movement of the rigid body relatively to it, the local deformation is represented by a second point x which tracks the position of initial point of contact on the surface of the rigid object inside the boundary of the undeformed object. Hence, a deflection d_{c}=x−c is readily defined at all times during a virtual contact. For the case of impedance synthesis, a method was disclosed whereby all the components of the contact force f_{c} could be computed given x for any initial contact point with assurances of accuracy and continuity, using a two step interpolation process, when in fact, the exact value of this force was known only at a finite number of points on the boundary of the undeformed body. For admittance synthesis, the same method could be used to compute x given f_{c} for any initial contact point.

To allow the possibility of simulated sliding friction, all what is now needed is to ensure that the point c moves on the surface of the undeformed body when the magnitude of the projection d^{t} of d over the surface of the undeformed body (and correspondingly f^{t}_{c}) is above a threshold. It is needed to provide for the additional specification of a coefficient μ, or more generally a univalued function μ( ), to relate the magnitude of the tangential force component to the normal force component:
f^{t}_{c}=μ(f^{z}_{c})=(f^{x}_{c}²+f^{y}_{c}²)^{1/2}
The point c should occupy a new location on the surface of the undeformed body only when f^{t}_{c} is found to exceed μ(f^{z}_{c}). The new location is such that f^{t}_{c}=μ(f^{z}_{c}). An efficient solution to this equation for the incremental movement of c location is already provided in (Hayward and Armstrong, 2000) for a variety of cases, including small stick-slip oscillations.

The univalued function μ( ) 340 may be recorded at the nodes of the virtual deformable body as in FIG. 3 and determined during a pre-processing stage like the deflection response curves, and interpolated in the same fashion during synthesis. Some steps in the flowcharts of FIG. 5 and FIG. 6 are the slightly modified.

Referring again to the flowchart in FIG. 5, step 525 can now be further described with the aid of FIG. 5a. For synthesizing friction which occurs when there is contact as determined by test 521, at step 526 the point c must be set to a location which is such that f^{t}_{c}=μ(f^{z}_{c}) as is already described. Since point c may cross the boundary of the element held in the buffer, this occurence is checked at step 527. If indeed is does cross the boundary, then the corresponding neighboring element is determined at step 528 and then is used to update the element in the buffer at step 529. Then, the control returns to step 530 in FIG. 5.

Referring now to FIG. 6, steps 617 and 657 can be further described with the aid of FIG. 6a FIG. 6b. Step 617 of FIG. 6 is replaced by the flowchart of FIG. 6a and step 657 replaced by the flowchart of FIG. 6b. Step 618 results from a contact so point c must be set to a location which is such that f^{t}_{c}=μ(f^{x}_{c}). If as a result c does cross an edge of the active element in the high rate buffer according to check 619, then control can proceed with step 530. If c crosses indeed an edge a new active element form low rate process is sought at step 620. If there is no element, control is returned to step 640. If the same element is found as that already in the high rate buffer, c is constrained to remain on the edge and control is returned to step 530. If instead a neighbor element is obtained, c is relocated to the neighbor element and control is returned to step 530. Refering now to FIG. 6b, step 658 determines whether c crosses an edge of the element in the buffer of low rate process. If it does not, control is returned to step 655, otherwise, the neighboring element is found and control is returned to 661.

It is known to those skilled in the art that self-sustaining oscillations can develop while interacting with a force reflecting viral environment. It can however be demonstrated that these oscillations do not occur if all the interconnected components of a system in a virtual environment possess the property of passivity. Passivity for a component means that this component does not generate energy. It can be shown that passivity is related to the existence of conservative fields (force or velocity fields as the case may be), a property that can be demonstrated for the fields generated by the double interpolation process. It is also the case that these fundamental properties will be nearly maintained even in the case when the simulated deformable bodies have time varying boundaries and time varying material properties, provided that these properties vary sufficiently slowly.

A correspondingly passive force reflecting the virtual environment not only more closely simulates the response of a nominal environment, but as mentioned above, also guarantees the stability of the interactions during which the user does not intend to destabilize the interaction. A discrete-time simulation of a nominally passive continuous-time environment will generally become active. However, with a sufficiently high update rate, the discrete-time simulation of a passive continuous-time environment will result in passive force responses. This is because any material system such as the mechanical components used to manufacture a haptic device always yield residual dissipation no matter-how well it is manufactured.

Thus, to ensure a passive response, high update rates of the force response are desired win synthesizing a response to an input force acting on a deformable body. That is, evaluation of interaction forces through interpolation of stored responses are advantageously performed at a high rate, something that the algorithm represented by the flow chart 600 provides because the identification of the currently active polygon as the rigid virtual object 230 moves along the surface of the virtual deformable body 200 can be performed at a lower rate. The resulting lag will only have a marginal effect on the accuracy of the synthesis.

In fact, with the approach disclosed here, the fidelity of the sensations experienced by a user will be entirely function of the ability of the haptic devices employed to transform the signals resulting from synthesis, namely, the ability of the device to create forces without deleterious effects resulting from transmission friction, damping and structural dynamics for the case of impedance synthesis, or the ability of the device to track position commands without limitations resulting from tracking rate, tracking accuracy and other imprecision resulting from its construction and its control for admittance synthesis.

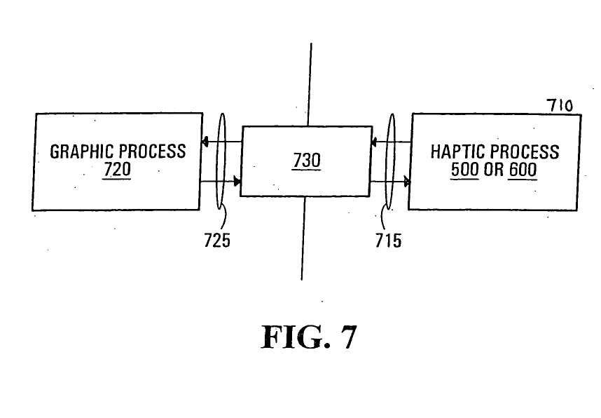

In some situations, it is needed to couple a virtual interaction synthesis experienced by users via mechanical signals as described herein with concomitant a graphical representation using a computer graphic screen or with other methods such as stereo video projection goggles and the like. With reference to FIG. 7, a communication device of similar nature as 601 and 602 is uses to transmit data resulting from the haptic process 710 to another process 720 constructed to synthesized the visual aspect of the virtual interaction. Signal 715 may advantageously transmit information computed by the process 710 such as the location of points c and x, the deflection d, the force-deflection curves or the deflection-force curves, the identity of the active element, and other information which can contribute to augment the realism of the visual aspect of the synthesized virtual interaction. Alternatively, information computed or stored by the graphic process 720 may be transmitted to the haptic process 710 for similar purposes.

The processing unit 120 may be implemented as one or several arithmetic and logic unit (ALU) having access to a code memory (not shown) which stored program instructions for the operation of the ALU. The program instructions could be stored on a medium which is fixed, tangible and readable directly by the processor, (e.g., removable diskette, CD-ROM, ROM, or fixed disk), or the program instructions could be stored remotely but transmittable to the processing unit 120 via a modem or other interface device (e.g., a communications adapter) connected to a network over a transmission-medium. The transmission medium may be either a tangible medium (e g, optical or analog communications lines) or a medium implemented using wireless techniques (e.g., microwave, infrared or other transmission schemes).

Those skilled in the art should also appreciate that the program instructions stored in the ode memory can be compiled from a high level program written in a number of programming languages for use with many computer architectures or operating systems. For example, the high level program may be written in assembly language, while other versions may be written in a procedural programming language (e.g., “C”) or an object oriented programming language (e.g., “C++” or “JAVA”)

Those skilled in the art should further appreciate that in some embodiments of the invention, the functionality of the processing unit 120 may be implemented as pre-programmed hardware or firmware elements (e.g., application specific integrated circuits (ASICs), electrically erasable programmable read-only memories (EEPROMs), etc.), or other related components.

Also, it will be understood that the model of the virtual deformable body 200, along with the basis vectors and the associated force responses, can be downloaded into the memory 110 via the internet or they can be provided on a medium such as a CD-ROM

While specific embodiments of the present invention have been described and illustrated, it will be apparent to those skilled in the art that numerous modifications and variations can be made without departing from the scope of the invention as defined in the appended claims.

### REFERENCES

### Adopted by Reference Herein

V. Hayward, B. Armstrong, 2000. A New Computational Model Of Friction Applied To Haptic Rendering. In Experimental Robotics VI, Peter Corke and James Trevelyan (Eds), Lecture Notes in Control and Information Sciences, Vol. 250, Springer-Verlag, pp. 403-412.
P. Dupont, V. Hayward, B Armstrong, F. Altpeter 2002. Single State Elasto-Plastic Friction Models. IEEE Transactions on Automatic Control; 47(5):787-792.
P. Dahl., 1968. A Solid Friction Model. The Aerospace Corporation, El-Segundo, Calif., TOR-158(3107-8), 1968.
M. H. Muser, L. Wenning & M. O. Robbins, 2001. Simple Microscopic Theory of Amontons's Laws for Static Friction. Phys. Rev. Lett. 86, 1295-1298.
M. Mahvash, V. Hayward, 2003a. Passivity-Based High-Fidelity Haptic Rendering of Contact. In Press. To appear in the proceedings of the 2003-IEEE Int. Conf. on Robotics and Automation.
M. Mahvash, V. Hayward, 2003b. Haptic Simulation of a Tool in Contact With a Nonlinear Deformable Body. In Press. International Symposium on Surgery Simulation and Soft Tissue Modelling, IS4TM. To appear as Lecture Notes in Computer Science, Springer Verlag, N. Ayache, H. Delingette (Eds).
Mahvash, M., Hayward, V., Lloyd, J. E. 2002. Haptic Rendering of Tool Contact. Proc. Eurohaptics 2002. pp. 110-115.
Mahvash, M., Hayward, V. 2001. Haptic Rendering of Cutting. A Fracture Mechanics Approach. Haptics-e, Vol. 2, No. 3.
J. K. Salisbury, D. Brock, T, Massie, N. Swarup, C. B. Zilles, 1995. Haptic Rendering: Programming Touch Interaction with Virtual Objects Symposium on Interactive 3D Graphics, Monterey Calif. USA.
C. B. Zilles, J. K. Salisbury, 1995. A Constraint-Based God Object Method for Haptic Display. Proc IEEE Int Conf. Intel. Rob. and Syst., Vol. 3, pp 146-151.

1. A method for synthesizing a response to interaction between a simulated toot having a tip and a simulated deformable body model having its surface modeled as being divided in a plurality of adjacent polygons, said method comprising the steps of:
a) receiving data from a data-source device indicative of the position of said tip on the simulated tool relative to the position of a point of initial contact between the tool tip and the undeformed simulated body;
b) displacing the tool tip to establish a deflection from said point of initial contact;
c) determining the deflection from said point of initial contact from the difference between the position of the simulated tool tip and the point of initial contact;
d) identifying the active polygon that includes the point of initial point of contact;
e) determining the position of the point of initial contact within the active polygon;
f) interpolating coordinate systems having at least one coordinate recorded with respect to each of the vertices of the active polygon;
g) interpolating from the components of the deflection, the force response along each said coordinate from responses recorded at the vertices of the active polygon to provide data indicative of the force response at the point of contact, and
h) sending to a data receiving device the data indicative of the force response at the point of initial contact as a synthesized force signal constituting a synthesized to response.

2. A method for synthesizing a response to interaction between a simulated tool having a tip and a simulate deformable body model-having its surface modeled as being divided in a plurality of adjacent polygons, said method comprising the steps of:
a) receiving data from a data-source device indicative of the position of said tip relative to the position of a point of initial contact between the tool tip and the undeformed simulated body and indicative of the force associated with the tool tip as it contacts the surface;
b) displacing the tool tip to establish a deflection from said-point-of-initial contact;
c) identifying the active polygon that includes the point of initial point of contact;
d) determining the position of the point of initial contact within the active polygon;
e) interpolating coordinate systems having at least-one coordinate recorded with respect to each of the vertices of the active polygon;
f) interpolating from the components of the force, the displacement response along each said coordinate from responses recorded at the vertices of the active polygon to provide data indicative of the displacement response at the point of contact, and
g) sending to a data receiving device the data indicative of the displacement response at the point of initial contact as a synthesized displacement signal.

3. A method for synthesizing a response of a simulated tool sliding over a simulated deformable body model as in claim 1, said method including the step of permitting the point of initial contact to move over the surface of the undeformed body such that the magnitude of the tangential component of the deflection projected over the surface of the undeformed body is smaller than a bound that depends on the normal deflection component.

4. A method as in claim 3, wherein the deflection data arising from the point of initial contact, upon moving said point of contact over the surface, is preserved at the value created when the point of contact is about to leave the active polygon until data for a new-active polygon is established, and thereafter is determined by the deflection data for such new active polygon.

5. A method for synthesizing a response of a simulated tool sliding over a simulated deformable body model as in claim 2, said method including this step up permitting the point of initial contact to move over the surface of the undeformed body such that the magnitude of the tangential component of the force projected over the surface of the undeformed body is smaller than a bound that depends on the normal force component.

6. A method as in claim 5, wherein the force data arising from the point of initial contact, upon moving said point of contact over the surface, is preserved at the value created when the point of contact is about to leave the active polygon until data for a new active polygon is established, and thereafter is determined by the force data for such new active polygon.

7. A method to couple a high rate process as in claim 1 to a process suitable to deliver, at low rate, response data having a lag and associated with an active polygon such that, if the response data represents a conservative-force field, the synthesized force signal is dissipative with respect to displacement, comprising the detection of establishment of virtual contact and removing from the deflection the offset corresponding to the lag in the said detection of establishment of the virtual contact.

8. A method to couple a high rate process as in claim 2 to a process suitable to deliver, at low rate, response data having a lag and associated with an active polygon such that, if the response data represents a conservative force field, the synthesized force signal is dissipative with respect to displacement, comprising the detection of establishment of virtual contact and removing from the deflection the offset corresponding to the lag in the said detection of establishment of the virtual contact.

9. A method to couple a high rate process as in claim 3 to a process suitable to deliver, at low rate, response data having a lag and associated with an active polygon such that, if the response data represents a conservative force field, the synthesized force signal is dissipative with respect to displacement, comprising the detection of establishment of virtual contact and removing from the deflection the offset corresponding to the lag in the said detection of establishment of the virtual contact.

10. A method to couple a high rate process as in claim 4 to a process suitable to deliver, at low rate, response data having a lag and associated with an active polygon such that, if the response data represents a conservative force field, the synthesized force signal is dissipative with respect to displacement, comprising the detection of establishment of virtual contact and removing from the deflection the offset corresponding to the lag in the said detection of establishment of the virtual contact.

11. A method to couple a high rate process as in claim 5 to a process suitable to deliver, at low rate, response data having a lag and associated with an active polygon such that, if the response data represents a conservative force field, the synthesized force signal is dissipative with respect to displacement, comprising the detection of establishment of virtual contact and removing from the deflection the offset corresponding to the lag in the said detection of establishment of the virtual contact.

12. A method to couple a high rate process as in claim 6 to a process suitable to deliver, at low rate, response data having a lag and associated with an active polygon such that, if the response data represents a conservative force field, the synthesized force signal is dissipative with respect to displacement, comprising the detection of establishment of virtual contact and removing from the deflection the offset corresponding to the lag in the said detection of establishment of the virtual contact.

13. A method of synthesizing a response to an input force acting on a deformable body having a surface modeled as a mesh of polygons, said method comprising:
receiving data indicative of an input force acting on the deformable body at a point of contact;
a) identifying the polygon that includes the point of contact, said polygon being a currently active polygon;
b) determining a relative: position of the point of contact within the currently active polygon;
c) obtaining force response data associated with the currently active polygon;
d) jointly processing the force response data and the relative position to produce data indicative of a force that is reactional to the input force;
e) outputting the data indicative of the force that is reactional to the input force.

14. The method defined in claim 13 wherein receiving data indicative of an input force acting on the deformable body at a point of contact comprises receiving a deflection conveying an input force magnitude and an input force direction with respect to the point of contact.

15, The method defined in claim 14 wherein determining a relative position of the point of contact within the currently active polygon comprises determining a weight associated with each of the vertices of the currently active polygon and wherein obtaining force response data associated with the currently active polygon comprises loading the force response data associated with the currently active polygon from a memory.

16, The method defined in claim 14 wherein each polygon in the mesh of polygons is defined by a plurality of vertices, wherein:
a) loading the force response data-associated with the currently active polygon comprises loading force response data associated with each vertex of the currently active polygon;
b) the force response data associated with each vertex of the currently active polygon conveys a magnitude and a direction of the force response at that vertex;
c) the force response data associated with each vertex of the currently active polygon conveys a magnitude component in each of at least two basis directions, and
d) the basis directions include a first basis-direction and a second basis direction, wherein the magnitude component in the first basis direction is a first magnitude component and wherein the magnitude component in the second basis direction is a second magnitude component, wherein the force response data associated with each vertex of the currently active polygon further conveys the first and second basis directions.

17. The method defined in claim 14 wherein jointly processing the force response data and the relative position to produce data indicative of a force that is reactional to the input force comprises:
a) determining a first basis direction for the reactional force from the first basis direction of each vertex in the active polygon and the weight associated with that vertex, and
b) determining a second basis direction for the reactional force from the second basis direction of each vertex in the active polygon and the weight associated with that vertex.

18) The method defined in claim 14 wherein jointly processing the force response data and the relative position to produce data indicative of a force that is reactional to the input force comprises:
a) determining a first magnitude component for the reactional force from the first magnitude component of each vertex in the active polygon and the weight associated with that vertex, and
b) determining a second magnitude component for the reactional force from the second magnitude component of each vertex in the active polygon and the weight associated with that vertex.

19. The method defined in claim 18 wherein the data indicative of the reactional force conveys a vector that is the sum of the first magnitude component for the reactional force in the first basis direction for the reactional force and the second magnitude component of the reactional force in the second basis direction for the reactional force.

20. The method defined in claim 18 wherein the data indicative of the reactional force conveys a vector having:
a) a first component with a magnitude corresponding to the first magnitude component for the reactional force and a direction corresponding to the first basis direction for the reactional force; and
b) a second component with a magnitude corresponding to the second magnitude component for the reactional force and a direction corresponding to the second basis direction for the reactional force.
